(19) United States
(12) Patent Application Publication
(10) Pub. No.: US 2007/0063973 A1
(43) Pub. Date: Mar. 22, 2007

(54) Method for inputting letter using pointer for portable device and the portable device

(76) Inventors: Ahn Keon Joon, Kyunggi-do (KR); Chul Park, Kyunggi-do (KR); Jae Dong Kim, Kyunggi-do (KR); Jae Hun Bae, Kyunggi-do (KR)

Correspondence Address: HAMMER & HANF, PC, 3125 SPRINGBANK LANE, SUITE G, CHARLOTTE, NC, 28226, US

(21) Appl. No.: 10/579,703

(22) PCT Filed: Jun. 7, 2005
(86) PCT No.: PCT/KR05/01698

§ 371 Date: May 19, 2006

(30) Foreign Application Priority Data
Oct. 5, 2004 (KR) 10-2004-0078941
Feb. 12, 2005 (KR) 10-2005-0011713

(51) Int. Cl. G09G 5/08

(52) U.S. Cl. 345/157

(57) ABSTRACT

A character input method for a portable device including a display screen and the portable device are provided. The character input method for a portable device includes a step of locating a pointer at a predetermined pointer start area on the display screen; a step of sensing the movement of an object which moves being in contact with an optical interface unit of the portable device; a step of inputting a character by moving the pointer from the pointer start area according to the sensed movement; and a step of returning the pointer to the pointer start area according to the input of the character. According to the present invention, an optical interface unit is installed in a portable device supporting character input and a character is input by moving a pointer via sensing the movement of an object in contact with the optical interface unit, thereby providing a character input method for a portable device and the portable device, which embody an optimized character input type maximizing convenience of users.

### TECHNICAL FIELD

The present invention relates to a character input method for a portable device including a display screen and the portable device, and more particularly, to a character input method for a potable device and the portable device, which is out of a conventional keypad input method in inputting a character in a small-sized portable device such as a mobile phone, displays a keyboard such as number character board on a display screen of the portable device, inputs a character by moving a pointer via a predetermined optical interface unit installed at the portable device, and returning the pointer to the original position after the character is inputted.

### BACKGROUND ART

Currently, most of PC users use Windows as an operating system (OS) of the PC of the user. This is due to convenient mouse functions and various graphic functions, which are not supported by a conventional DOS system. In case that a certain command is inputted via Windows, a user may simply input a command via dragging, scrolling, and clicking a mouse.

On the other hand, a keypad push input type is still chiefly used as an input method in a small-sized portable device such as a mobile phone. This is due to the limitation of the thickness of a module used in other input methods. A thick module can not be used due to the configuration of a mobile phone such as the location and the thickness of a Printed Circuit Board (PCB), the location of important elements such as RF module.

As described above, though graphics displayed on a screen or various functions of a small-sized portable device are similar to Windows of a PC, since an input means of the portable device is a keypad, there is a great inconveniences with respect to inputting a command, input speed, and scrolling various displayed graphic screens.

Also, since the keypad input method is a push type by mono move that can move one by one in inputting a telephone number or using other menus, there are not only a problem in time and operation but also a problem in which the keypad input method can not be used in Graphic User Interface (GUI).

### DISCLOSURE OF INVENTION

Technical Goals

The present invention is provided to improve the described conventional art. According to the present invention, an optical interface unit is installed in a portable device supporting character input and a character is input by moving a pointer via sensing the movement of an object in contact with the optical interface unit, thereby providing a character input method for a portable device and the portable device, which embody an optimized character input type maximizing convenience of users.

Also, according to the character input method for a portable device and the portable device of the present invention, the pointer is located in a pointer start area of a display screen in displaying the pointer of the portable device, the pointer is moved to a predetermined area according to the movement of the object, and a method of returning to the original position method is provided, in which the pointer is returned to the pointer start area in case that it is sensed that the object is out of contact with the optical interface unit, thereby obtaining an effect of optimizing pointer movement control of a user.

Also, according to the character input method for a portable device and the portable device, a character image corresponding to a series of movements of the object, which are sensed by the optical interface unit of the portable device is generated and character data corresponding to the generated character image is extracted and displayed, thereby obtaining an effect of inputting a character simply by moving the object.

Technical Solutions

To achieve the goals and solve the problems ofthe conventional art, a character input method for a portable device according to the present invention includes a step of locating a pointer at a predetermined pointer start area on the display screen; a step of sensing the movement of an object which moves being in contact with an optical interface unit of the portable device; a step of inputting a character by moving the pointer from the pointer start area according to the sensed movement; and a step of returning the pointer to the pointer start area according to the input of the character.

A portable device widely mentioned in the present specification indicates a mobile communication terminal such as a Personal Digital Assistant (PDA), a handheld PC, and a mobile phone having operation ability by including a predetermined memory and equipping with a predetermined microprocessor. Also, the portable device is a portable multimedia that can regenerate multimedia files such as music or moving pictures, which may include all sorts of portable device such as an MP3 player, an MP3 phone, a PDP, a PMP, and a DMB receiving device.

Also, in the present specification, inputting “a character” means not only inputting a narrow meaning of a character but also inputting a number, a symbol, or an equation by using the character input method according to the present invention or selecting all sorts of items such as menus or icons. Accordingly, the character input method for a portable device according to the present invention includes not only a method of simply inputting a character but also all of methods of inputting and selecting various items in addition to inputting the character

### BRIEF DESCRIPTION OF DRAWINGS

FIG. 1 is block diagram illustrating the configuration of a portable device according to a first embodiment of the present invention;

FIG. 2 is a diagram illustrating the configuration of an optical module that is can be installed at an optical interface unit of the portable device of the present invention;

FIG. 3 is a diagram illustrating an example of a method of inputting a character by using the portable device according to the first embodiment of the present invention;

FIG. 4 is a diagram illustrating another example of the method of inputting a character by using the portable device according to the first embodiment of the present invention;

FIG. 5 is a block diagram illustrating the configuration of a portable device according to a second embodiment of the present invention;

FIG. 6 is a diagram illustrating an example of displaying a character image and character data of the portable device according to the second embodiment of the present invention;

FIG. 7 is a flow chart illustrating a character input method for the portable device according to the first embodiment of the present invention; and

FIG. 8 is a flow chart illustrating the method of inputting a character of the portable device according to the second embodiment of the present invention.

### BEST MODE FOR CARRYING OUT THE INVENTION

Hereinafter, the embodiments of the present invention are described in detail with reference to the attached drawings.

FIG. I is block diagram illustrating the configuration of a portable device according to a first embodiment ofthe present invention.

A portable device 100 according to the first embodiment of the present invention provides a pointer on a display screen, receives a command of moving the pointer in a certain direction from a user via an optical interface unit, receives a selection with respect to a predetermined display item in which the pointer moved in the direction is located, and executes the display item.

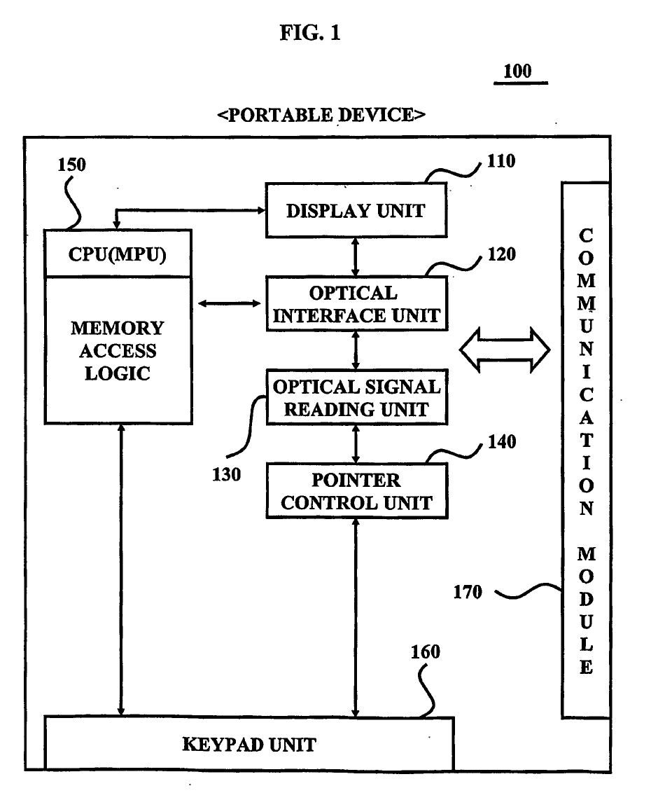

The portable device 100 according to the first embodiment of the present invention, which is illustrated in FIG. 1, includes a display unit 110, an optical interface unit 120, an optical signal reading unit 130, a pointer control unit 140, a central processing unit 150, a keypad unit 160, and a communication module 170.

The display unit 110 displays at least one display item or a predetermined pointer. The at least one display item is a concept including a predetermined menu item, icon, number, or character, which can be selected for performing functions supported via the portable device 100 by the user.

The display unit 110 displays all sorts of display items of the portable device to show to users. An STN LCD, a TFT LCD, and an organic EL LCD currently used may be used as the display unit 110.

The optical interface unit 120 contacts with a predetermined object, emits an optical signal to the object, and receives the optical signal reflected by the object. For example, in case that a user contacts a finger of the user with the optical interface unit 120, the optical interface unit 120 emits an optical signal to the finger of the user, receives the optical signal reflected by the finger, and senses the movement of the finger of the user via the received optical signal.

The optical interface unit 120 may be embodied via a predetermined optical module generally known to those skilled in the art and used. For example, an optical module included in an optical mouse used as an input means of a PC may be used. Also, an optical module having a horizontal structure made by changing a horizontal structure of the optical module may be used as the optical interface unit 120 in order to minimize and slim.

When an optical image sensor is used in an optical mouse used in a conventional PC, since an object surface is a bottom surface, a structure in which a light source emits downward and a lens is located below an image sensor is employed. However, in the structure, since the object surface, a lens system, and the optical image sensor are vertically arranged in the direction of an optical axis, the height is restricted due to the limitation of the focal length of the optical system. Due to the structure, the structure described above can not be applied to a small-sized portable device such as a mobile phone, which becomes minimized and slimmed.

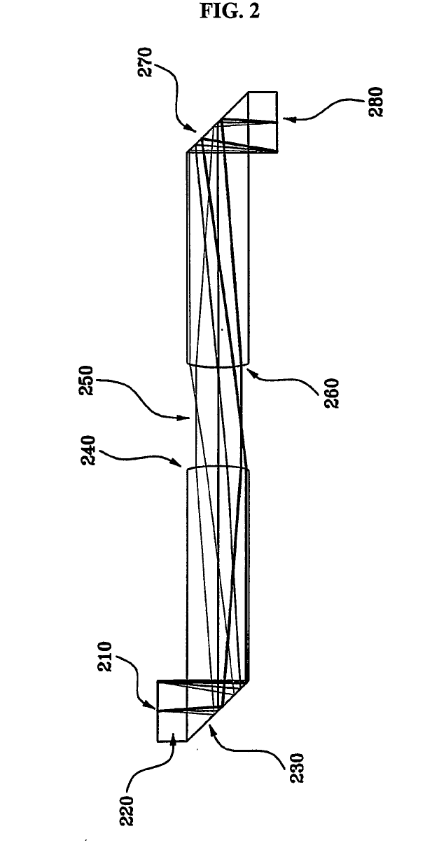

Namely, in case that an optical system applied to an optical mouse used in a general PC is employed, the height of a module may not be reduced to less than 4.Omm. However, the height is not sufficient to be applied to a small-sized portable device such as a mobile phone. In order to be applied to a mobile phone, the height has to be less than 1.5 to 2.0 mm. The structure of an optical system may be generally transformed for forming the module, which will be described with reference to FIG. 2.

FIG. 2 is a diagram illustrating the configuration of an optical module that may be installed at an optical interface unit of portable device according to the present invention.

As illustrated in FIG. 2, an optical module may be installed at the optical interface unit 120 of the present invention in order to minimize and slim the portable device 100. The optical module illustrated in FIG. 2 may include an object surface 210, a cover glass 220, reflecting surfaces 230 and 270, lens units 240 and 260, and an image surface 280.

In the optical module of FIG. 2, the object surface 210, the lens units 240 and 260, and the image surface 280 are embodied as a horizontal structure from a vertical structure to change the proceeding path of an optical signal, thereby providing a sufficient focal length and the depth of a focus and forming a module whose thickness is less than 2.0 mm. Generally, in case that the optical module is installed in a portable device that is small-sized, the thickness of the optical module is the most important. Accordingly, as the optical module illustrated in FIG. 2, an optical module in which the path of an optical signal is changed into a horizontal direction is installed in the portable device 100 according to the present invention, thereby obtaining an effect of minimizing and slimming the portable device if the optical module is installed.

Referring to FIG. 1, the optical signal reading unit 130 senses the received optical signal and reads the movement of the object. Namely, the state of receiving the optical signal reflected by the object is sensed via the optical interface unit 120, thereby reading the movement of the object. As widely used via an optical mouse, a method of reading the direction or a path of the movement of the object via generating a predetermined image according to the movement of the object may be applied as movement reading method. Also, the optical signal reading unit 130 measures the speed or distance of the move of the object to read in detail.

The pointer control unit 140 controls a pointer such that the pointer is moved in a predetermined direction corresponding to the read movement of the object. In case that the movement of the object is read, the optical signal reading unit 130 transmits information on the read movement of the object to the pointer control unit 140. The pointer control unit 140 receiving the information on the movement of the object determines the direction, speed, or distance of the movement of the object and moves the pointer corresponding to the determined direction, speed or distance.

In case that the pointer is moved to a certain position by the pointer control unit 140, a user may input a selection of a display item at which the pointer is located via a keypad unit 160. In case that the selection of the display item is inputted, the central processing unit 150 executes the display item. The display item may be a predetermined icon, menu, character, or number for executing functions supported by the portable device 100.

The central processing unit 150 may be embodied, including a general CPU for computer, performing operations, such as a Micro Processor Unit (MPU) and a Memory Access Logic (MAL). The central processing unit 150 is a kernel performing all sorts of commands inputted via the keypad unit 160 and controlling the operation of the display unit 110, optical interface unit 120, optical signal reading unit 130, and pointer control unit 140.

The keypad unit 160 is an input means including at least one keypad and may be embodied by at least one button included in a general portable device. The keypad unit 160 may include an optical interface unit 120.

The communication module 170 supports a communication function of the portable device 100 in general wired/wireless communication. The communication module 170 may include at least one of a serial, a Universal Serial Bus (USB), an infrared (IR) communication unit, a Bluetooth communication unit, or a mobile communication interface unit. The mobile communication interface unit may support at least one of Public Switched Telephone Network (PSTN) access, Code Division Multiple Access (CDMA), WCDMA, ALL IP, GSM, GPRS access method, and all sorts of existing access methods associated with mobile communication. Also, the mobile communication interface unit may be embodied to support at least one protocol of call control protocol for VoIP call connection, such as H.323, Message Gateway Control Protocol (MGCP), Session Initiation Protocol (SIP), or Megaco.

As explained via the configuration of the portable device 100 of FIG. 1, a user contacts a finger with the optical interface unit 120 to move the pointer to the position of a first display item that the user want and clicks a predetermined button included in a keypad unit 160, thereby executing the first display item in which the pointer is located. Also, the executed first display item may be transmitted to a predetermined terminal or server via the communication module 170.

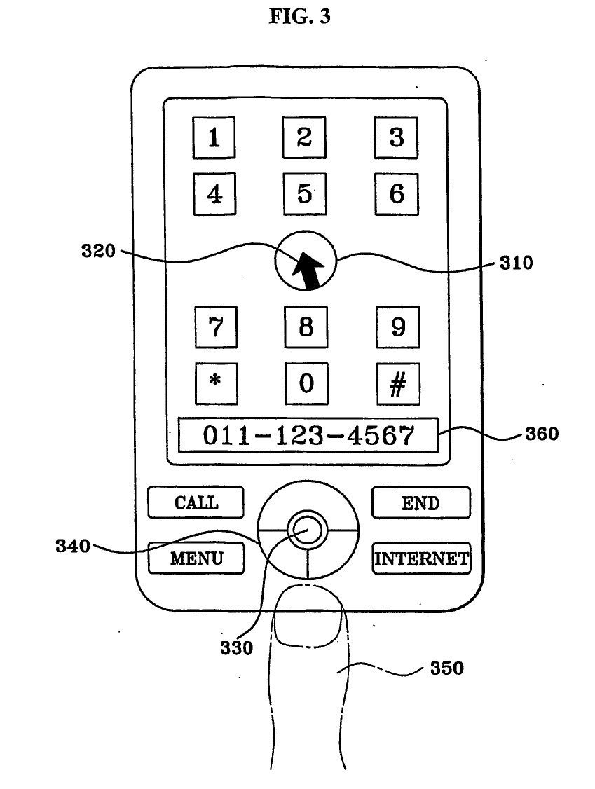

FIG. 3 is a diagram illustrating an example of a pointer display by using the portable device according to the first embodiment of the present invention.

In case that pointer display operation of the portable device is initially driven, the pointer control unit 140 may control the display unit 110 such that a pointer 320 is located at a pointer start area 310 of a display screen to be displayed. In case that the pointer 320 is located at the pointer start area 310, a user moves a finger 350 in contact with an optical interface unit 330 and may move the pointer 320 to a predetermined area.

As shown in FIG. 3, in case that at least one number is arranged in the display unit 110, the user may input a predetermined telephone number by moving the pointer 320. For example, in case that the user tries to input a telephone number such as “01 1-123-4567”, the pointer 320 is moved to the position of “0” via the movement of the finger 350 and the keypad is clicked in case that the pointer is moved to the position of “0”, thereby inputting the telephone number in a predetermined area 360.

After the user inputs a number by clicking the keypad 340, the finger 350 of the user is departed from the optical interface unit 330 and the contact ends. When the contact ends, the pointer 320 is moved to the pointer start area 310 again, thereby embodying a method of returning to the original position, in which the user can more conveniently input a number. The user can input the telephone number “011-123-4567” by repeating the operation described above and execute a telephone conversation.

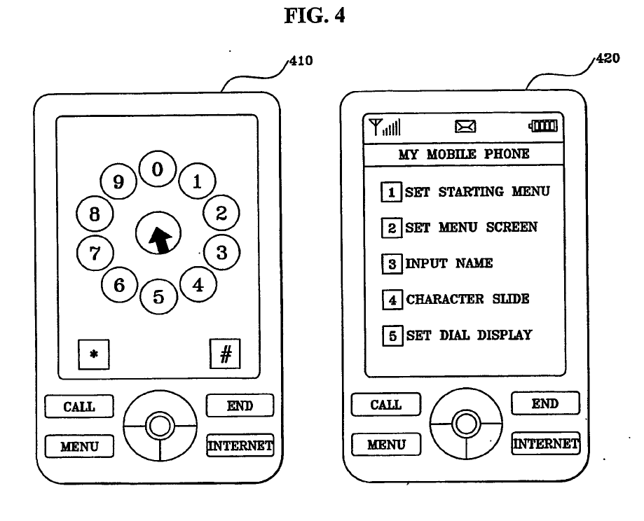

FIG. 4 is a diagram illustrating another example of a pointer display using the portable device according to the first embodiment of the present invention.

As a reference numeral 410 illustrated in FIG. 4, since at least one number is displayed as a circle around a pointer start area in which a pointer is located, the distance from the pointer start area to each number is the same. Therefore, a user may more rapidly and conveniently input the each number by using the method of returning to the original position.

Also, as a reference numeral 420 illustrated in FIG. 4, not only a number may be inputted but also all sorts of menu items may be selected via the pointer display of the portable device according to the first embodiment of the present invention. In case that the menu items are selected as described above, if the menu items too many to be all displayed, the user may conveniently moves the screen and search the menu by using scroll via an optical interface unit.

The scroll by using the optical interface unit may be applied to a case in which the user executes contents whose entirety is not displayed in a screen, such as an electronic book, via the portable device, thereby more conveniently using the contents.

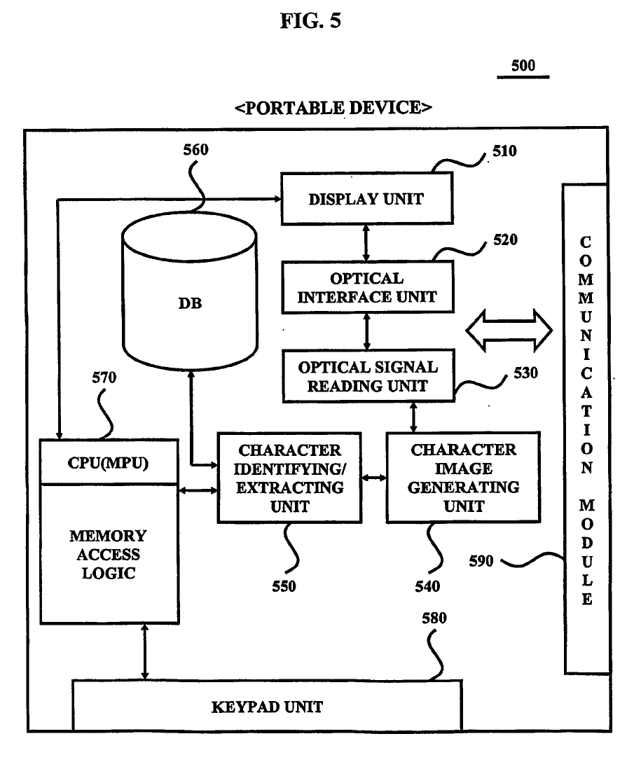

FIG. 5 is a block diagram illustrating the configuration of a portable device according to a second embodiment of the present invention.

A portable device 500 according to the second embodiment of the present invention can generate a character image according to the movement of an object, which is sensed via an optical interface unit 520 and extract character data corresponding to the generated character image from a database 560 to display.

The portable device 500 according to the second embodiment of the present invention includes a display unit 510, the optical interface unit 520, an optical signal reading unit 530, a character image generating unit 540, a character identifying/extracting unit 550, the database 560, a central processing unit 570, a keypad unit 580, and a communication module 590.

The display unit 510 displays a predetermined screen including a first area or a second area and displays a predetermined character image or character data on the screen. The display unit 510 is a means displaying all sorts of display items of the portable device 500 to a user. An STN LCD, a TFT LCD, or an organic EL LCD, which is currently used, may be used as the display unit 510.

The optical interface unit 520 contacts with a predetermined object, emits an optical signal to the object, and receives the optical signal reflected by the object. For example, in case that the user contacts a finger of the user with the optical interface unit 520, the optical interface unit 520 emits an optical signal to the finger of the user, receives the optical signal reflected by the finger, and senses the movement of the finger of the user via the received optical signal. The optical interface unit 520 may be embodied by applying the configuration and operation of the optical interface unit 120 of the portable device 100 according to the first embodiment of the present invention illustrated in FIG. 1.

The optical signal reading unit 530 senses the received optical signal and reads the movement of the object. Namely, a state of receiving the optical signal reflected by the object via the optical interface unit 520 and reads the movement of the object. As the optical interface unit 520, the optical signal reading unit 530 may be also embodied by applying the configuration and operation of the optical signal reading unit 130 of the portable device according to the first embodiment ofthe present invention.

The character image generating unit 540 generates a pointer character image displaying the read path. Namely, a pointer character image may be generated according to a path along which the object is moved, which is sensed by the optical signal reading unit 530. The pointer character image may be generated and display the path along which the object is moved in real time or generated and a display path according to a series of the movement after the series of the movement of the object has ended.

The character identifying/extracting unit 550 identifies the generated pointer character image and a character image corresponding to the generated pointer character image and extracts character data corresponding to the identified character image. For example, the pointer character image displaying the path according to the movement of the object may include somewhat of inaccuracy to be shown as a character, according to handwritings different for each user or all sorts of environmental factors. Accordingly, the character identifying/extracting unit 550 may identify a character image similar to the pointer character image drawn up by the user from the database 560 and extract character data corresponding to the identified character image, namely, a fixed character (for example, Ming type or Gothic type) data.

The database 560 includes and maintains at least one character image and character data corresponding to the character image, as described above. For example, character data F may be recorded corresponding to a character image T, and character data P may be recorded corresponding to a character image P. In the database 560, a character image and character data including at least one language may be recorded and all sorts of numbers, symbols, operators may be further recorded in addition to language characters.

The central processing unit 570 controls the display unit 510 such that the generated pointer character image is displayed in the first area of the screen and extracted character data is displayed in the second area of the screen.

The central processing unit 570 may be embodied, including a CPU for a general computer performing operation, such as Micro Processor Unit (MPU) and memory access logic. The central processing unit 570 that is a core element of the portable device 500 may perform all sorts of commands inputted via the keypad unit 580 and control the operations of the display unit 510, the optical interface unit 520, the optical signal reading unit 530, the character image generating unit 540, and the character identifying/extracting unit 550.

The keypad unit 580 is an input means including at least one keypad, which may be embodied by at least one button included in the portable device 500. The keypad unit 580 may include the optical interface unit 520.

The communication module 590 supports the communication function of the portable device 500, which supports general wired or wireless communication. The communication module 590 may include one of a serial, a Universal Serial Bus (USB), an infrared (IR) communication unit, a Bluetooth communication unit, or a mobile communication interface unit. The mobile communication interface unit may support at least one of Public Switched Telephone Network (PSTN) access, Code Division Multiple Access (CDMA), WCDMA, ALL IP, GSM, GPRS access method, and all sorts of existing access methods associated with mobile communication. Also, the mobile communication interface unit may be embodied to support at least one protocol of call control protocol for VoIP call connection, such as H.323, Message Gateway Control Protocol (MGCP), Session Initiation Protocol (SIP), or Megaco.

As described above, the user may generate a pointer character image by using the optical interface unit 520 of the portable device 500 according to the second embodiment of the present invention. The portable device 500 identifies a character image corresponding to the generated pointer character image, extracts character data corresponding to the identified character image, and displays the character data in the second area of the display unit 510, thereby obtaining an effect in which the user can more conveniently input a character by the movement of a finger instead of clicking the button ofthe keypad unit 580 one by one.

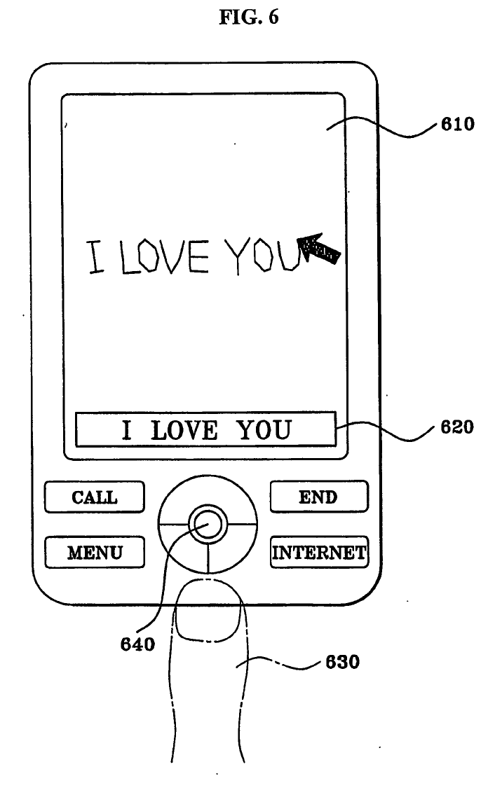

FIG. 6 is a diagram illustrating an example in which a character image and character data of the portable device according to the second embodiment of the present invention is displayed.

As illustrated in FIG. 6, the user contacts a finger 630 of the user with an optical interface unit 640 and inputs a series of movements. The portable device generates a pointer character image according to a path of the movement. For example, in case that x LOVE YOU is generated as a pointer character image according to the path of the movement and displayed in a first area 610, the character identifying/extracting unit may identify a character image similar to each character of each syllable included in the pointer character image from the database and extract character data corresponding to each the identified character image, thereby displaying character data having a fixed form such as I LOVE YOU in a second area 620.

The user may transmit the displayed character data to a predetermined terminal or a server via the communication module and store in a memory of the portable device.

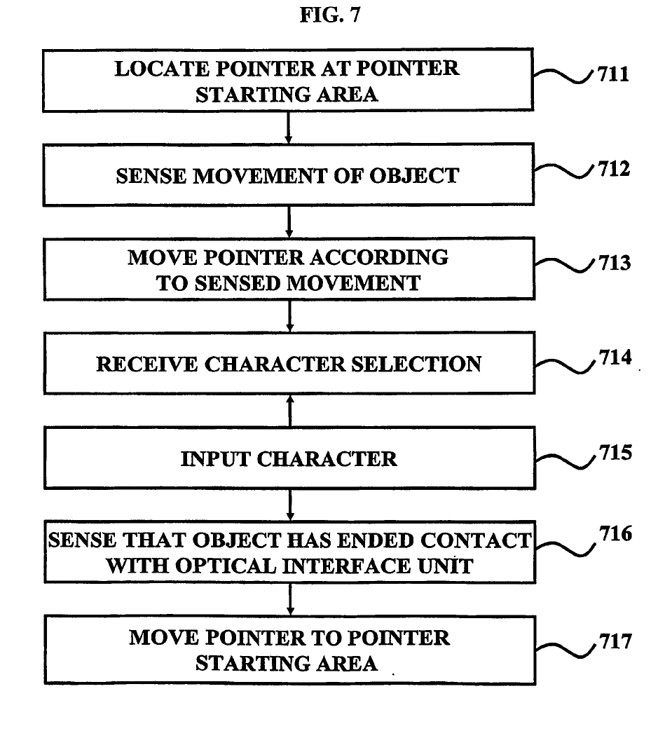

FIG. 7 is a flow chart illustrating a character input method for the portable device according to the first embodiment of the present invention.

The portable device according to the first embodiment of the present invention displays a pointer in a pointer start area of a display screen (Step 711). The movement of an object contacted via the optical interface unit is sensed (Step 712), and the portable device moves the pointer according to the sensed movement (Step 713).

In case that a selection on a character located in the position in which the pointer is moved in Step 713 is received from the user (Step 714), the portable device inputs the character (Step 715).

In case that it is sensed that the object has ended the contact via the optical interface unit (Step 716), the portable device moves the pointer located at the character to the pointer start area (Step 717). The pointer is moved to the pointer start area again in Step 717, thereby providing a more convenient character input method by using the method of returning to the original position.

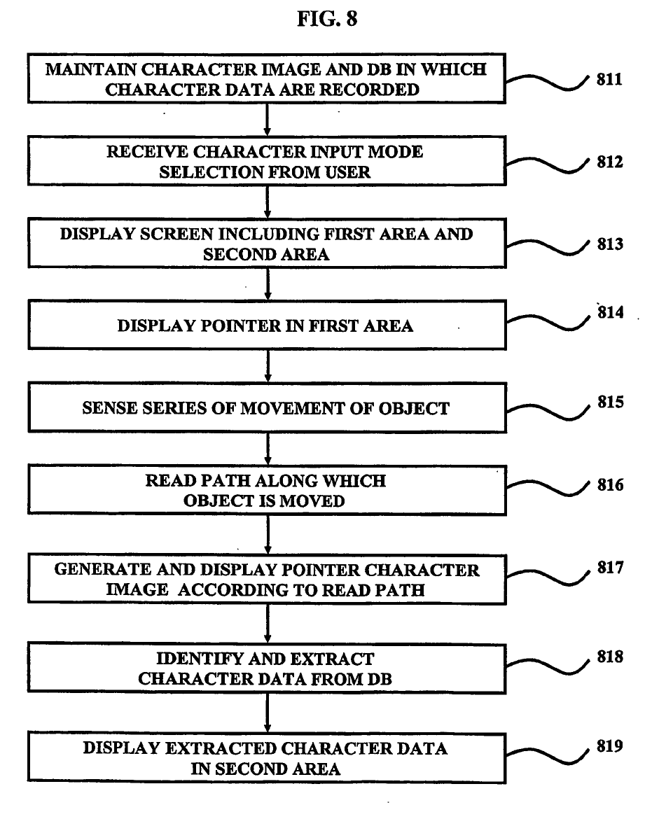

FIG. 8 is a flow chart illustrating a character input method for the portable device according to the second embodiment of the present invention.

The portable device according to the second embodiment of the present invention maintains a database in which at least one character image and character data corresponding to the character image are recorded (Step 811). In case that a character input mode selection by using a pointer is received from a user (Step 812), the portable device displays a screen including a first area or a second area (Step 813). The pointer may be displayed in the first area of Step 813 (Step 814).

The portable device senses a series of movements of the object contacted via the optical interface unit (Step 815) and reads a moving path of the object, which is corresponding to the sensed movements (Step 816). The portable device generates a pointer character image displaying the path according to the moving path read via Step 816 and displays in the first area (Step 817).

The portable device identifies a character image corresponding to the pointer character image from a database and extracts character data corresponding to the identified character image (Step 818). The extracted character data may be displayed in the second area of the display screen (Step 819) and stored in a predetermined memory of the portable device.

As described above, the user can more conveniently input a character, number, or a symbol by contacting a finger with the optical interface unit and moving the finger.

Also, the character input method for the portable device according to the embodiments of the present invention may include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter.

While this invention has been particularly shown and described with reference to preferred embodiments thereof, various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

### INDUSTRIAL APPLICABILITY

According to the present invention, an optical interface unit is installed in a portable device supporting character input and a character is input by moving a pointer via sensing the movement of an object in contact with the optical interface unit, thereby providing a character input method for a portable device and the portable device, which embody an optimized character input type maximizing convenience of users.

Also, according to the character input method for a portable device and the portable device of the present invention, the pointer is located in a pointer start area of a display screen in displaying the pointer of the portable device, the pointer is moved to a predetermined area according to the movement of the object, and a method of returning to the original position is provided, in which the pointer is returned to the pointer start area in case that it is sensed that the object is out of contact with the optical interface unit, thereby obtaining an effect of optimizing pointer movement control of a user.

Also, according to the character input method for a portable device and the portable device, a character image corresponding to a series of movements of the object, which are sensed by the optical interface unit of the portable device is generated and character data corresponding to the generated character image is extracted and displayed, thereby obtaining an effect of inputting a character simply by moving the object.

1. A method of inputting a character in a portable device having a display screen, comprising:
a step of locating a pointer at a predetermined pointer start area on the display screen;
a step of sensing the movement of an object which moves being in contact with an optical interface unit of the portable device;
a step of inputting a character by moving the pointer from the pointer start area according to the sensed movement; and
a step of returning the pointer to the pointer start area according to the input of the character.

2. The method of claim 1, wherein in the step of returning the pointer to the pointer start area according to the input of the character, the pointer is returned to the pointer start area in case that it is sensed that the object has ended the contact with the optical interface unit.

3. The method of claim 1, wherein in the step of inputting a character by moving the pointer from the pointer start area according to the sensed movement, the character is inputted in case that a character located at the area in which the pointer has moved is selected by a user.

4. The method of claim 1, wherein:
in the step of sensing the movement of an object which moves being in contact with an optical interface unit of the portable device, the movement is sensed by measuring at least one of the speed and the distance of the movement of the object; and
in the step of inputting a character by moving the pointer from the pointer start area according to the sensed movement, the pointer is moved in response to at least one of the measured speed and distance.

5. The method of claim 1, further comprising a step of maintaining a database in which at least one character image and character data are recorded corresponding to each other,
wherein the step of inputting a character by moving the pointer from the pointer start area according to the sensed movement comprises:
a step of generating a character image corresponding to the sensed movement;
a step of identifying and extracting character data corresponding to the generated character image from the database; and
a step of displaying the extracted character data on the display screen.

6. A computer readable recording medium in which a program for executing a method of inputting a character in a portable device having a display screen, comprising:
a step of locating a pointer at a predetermined pointer start area on the display screen;
a step of sensing the movement of an object which moves being in contact with an optical interface unit of the portable device;
a step of inputting a character by moving the pointer from the pointer start area according to the sensed movement; and
a step of returning the pointer start area according to the input of the character.

7. A portable device capable of inputting characters, comprising:
a display unit for displaying a predetermined character or a pointer on a predetermined display screen;
an optical interface unit contacting with a predetermined object, emitting an optical signal to the object, and receiving an optical reflection signal reflected from the object;
an optical signal sensing unit sensing the movement of the object by interpreting the received optical reflection signal and; and
a pointer control unit locating the pointer at a pointer start area on the display screen, inputting a character by moving the pointer from the pointer start area according to the sensed movement, and returning the pointer to the pointer start area according to the input of the character.

8. The portable device of claim 7, wherein the pointer control unit returns the pointer to the pointer start area in case that it is sensed that the object has ended the contact with the optical interface unit.

9. The portable device of claim 7, further comprising:
a database maintaining at least one character image and character data corresponding to the character image;
a character image generating unit generating a pointer character image corresponding to the sensed movement; and
a character identifying/extracting unit identifying a character image corresponding the pointer character image from the database and extracting character data corresponding to the identified character image.

10. The portable device of claim 7, wherein the optical interface unit comprises a predetermined object surface to which the optical signal is transmitted, a lens, and an image surface, the object surface, the lens, and the image surface are horizontally disposed.
